(19) United States
(12) Patent Application Publication
(10) Pub. No.: US 2006/0207808 A1
(43) Pub. Date: Sep. 21, 2006

(54) Counterintuitive Physics Demonstration Mechanism

(76) Inventor: David Milton Durlach, Somerville, MA (US)

Correspondence Address: Mr. David Milton Durlach;TechnoFrolics, 11 Miller Street, Somerville, MA, 02143, US

(21) Appl. No.: 11/306,950

(22) Filed: Jan. 17, 2006

Related U.S. Application Data
(60) Provisional application No. 60/645,830, filed on Jan. 24, 2005.

(51) Int. Cl. B62D 57/00

(52) U.S. Cl. 180/7.4

(57) ABSTRACT

A vehicle designed to harness the kinetic energy of a stream of gas or liquid aimed in a constant direction toward its front end, with the surprising and educational result that it moves into the oncoming stream.

### CROSS-REFERENCE TO RELATED APPLICATIONS

This application is entitled to the benefit of Provisional Patent Application Ser. No. 60/645,830 filed 2005, Jan. 24 by the present inventor.

### FEDERALLY SPONSORED RESEARCH

n/a

### SEQUENCE LISTING OR PROGRAM

n/a

### BACKGROUND—DISCUSSION OF PRIOR ART

There have been numerous attempts at inventing propeller-driven wind-powered vehicles. Most of these attempts have been directed toward the development of vessels for use on water (see Jost and Imura). Others have been additionally directed toward land-based vehicles (see Rettman and Willis). All of these previous attempts have included sophisticated mechanisms that allow for steering of the vehicles while maintaining their propellers in a constant position relative to wind direction and/or a system for varying the pitch of the propeller blades in order to control the speed of rotation. While it is certainly useful in most circumstances for vehicles to have the abilities to steer and control speed, those abilities do come at the cost of simplicity. Furthermore, there are situations in which the abilities to steer and control speed have no advantage over a rigid system in which neither is possible.

### OBJECTS AND ADVANTAGES

The object of this invention is to provide a simple vehicular device capable of harnessing the energy of a stream of gas or liquid when the device is specifically facing into the oncoming stream. By thus limiting the scope of the field of application, my invention has a distinct advantage over the prior art in view of its simplified construction. By eliminating the requirements of steering ability and propeller pitch control, my invention can be manufactured much more economically. In circumstances where they are not necessary, the additional mechanical requirements associated with steering ability and propeller pitch control in such vehicles indeed present a disadvantage because of the additional manufacturing costs involved.

Such circumstances where my invention presents an advantage over the prior art include:
A. Physics demonstrations in which simple principles of propeller-driven locomotion are involved.
B. Toys.
C. Situations in constrained conditions, such as inside pipes or on rails or tracks, or in wind tunnels, and in which a stream of gas or liquid is being directed at the propeller from a constant direction.
D. Mechanical artworks.

### SUMMARY

In accordance with the present invention, a propeller-driven vehicle is powered by a stream of gas or liquid directed toward the propeller in a constant direction, with the result that the vehicle moves forward in the direction of the oncoming stream.

### DRAWING FIGURES

There are two depicted figures of a preferred embodiment of the present invention.

FIG. 1A shows a perspective view of the invention as seen from the side and front. The figure shows a three-wheeled vehicle with a nose cone and propeller mounted on the front end. The propeller assembly is connected via a shaft that runs through the body of the vehicle and drives the rear wheels via a pair of bevel gears.

FIG. 1B shows the view described in FIG. 1A projected from above. In this view, the drive train is visible within the rear mounting block. The propeller shaft can be seen projecting into the rear mounting block and driving the bevel gear assembly, which in turn drives the rear wheels.

### REFERENCE NUMERALS IN DRAWING

The following reference numbers are provided:

Definition List 1

| Term | Definition |
|---|---|
| 9 | propeller blades |
| 4 | front wheel |
| 5 | front wheel axle |
| 10 | nose cone |
| 1 | front mounting block |
| 2 | body tube |
| 6 | rear mounting block |
| 3 | propeller drive shaft |
| 8 | rear wheels |
| 7 | rear wheel axle |
| 11 | small bevel gear |
| 12 | large bevel gear |

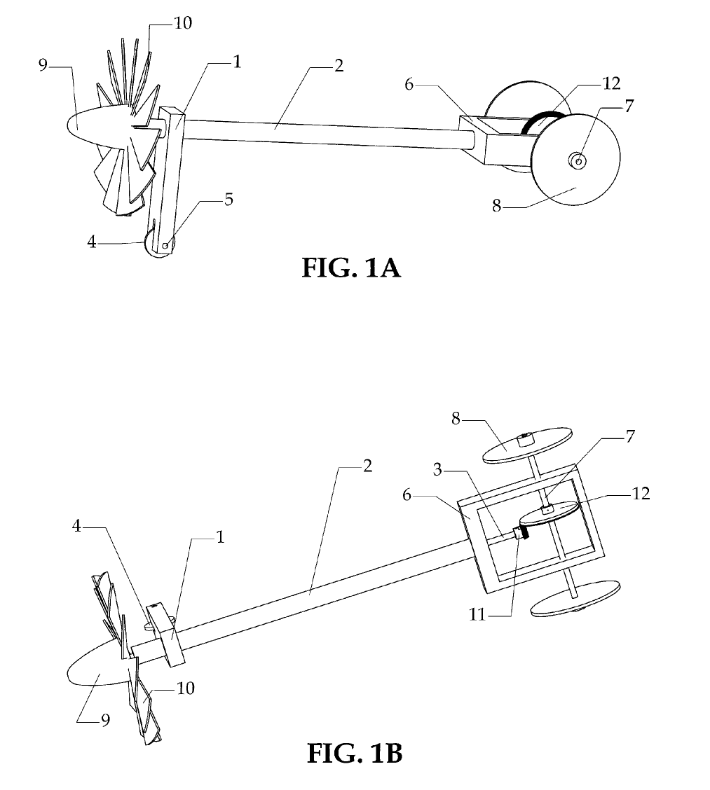

### DESCRIPTION OF INVENTION—FIGS. 1A, 1B

A preferred embodiment of the present invention is illustrated in FIGS. 1A and 1B. The embodiment depicted describes a table-top vehicle for use as a toy or as a physics demonstration model. When used as a physics demonstration model, the counterintuitive behavior that the device displays can be applied to lessons in mechanics and energy transfer. Specifically, when a stream of air or water—or any gas or liquid—is directed toward the propeller, the vehicle moves against the direction of the stream. Normally, when a stream is directed toward an object, the object is expected to move away, in the direction of the stream flow. The fact that the illustrated vehicle moves into the stream flow demonstrates the counterintuitive nature of energy transfer, and how a mechanism can be used to redirect energy in any direction, even against the direction from which the source of energy originated.

The illustrated embodiment is a vehicle with three wheels, one 4 in front, and two 8 in the rear. A nose cone and propeller assembly 9,10 are mounted on a drive shaft 3 that is rotatably housed in a tube 2 that forms the main body of the vehicle. The main body tube 2 is secured into two support blocks. The front support block 1 is raised from the ground by a single wheel 4 and axle 5. The rear support block is raised from the ground by two wheels 8 and a single axle 7 that connects them.

In a typical usage scenario, a stream of air or water is directed at the propeller blades 10, flowing around the nose cone 9 to maximize the effective force of the stream against the propeller blades 10. As the propeller 9, 10 rotates in response to the force of the stream being impelled upon it, it drives drive shaft 3. Drive shaft 3 conveys the rotational energy down through the main body tube 2, toward the rear mounting block 6, where the drive shaft exits main body tube 2 and drives large bevel gear 12 via small bevel gear 11. The bevel gears 11, 12, are proportioned to provide a mechanical advantage of at least a factor of 4, and further, to dispose the mechanical force in an axis perpendicular to the drive shaft 3 and in a reversed rotational direction. The large bevel gear 12 is connected to rear wheel axle 7, thereby driving rear wheels 8.

In order to maximize the effective transfer of energy from a stream of air, for example, into mechanical movement, it is important that friction be minimized as much as possible. Thus, in the illustrated embodiment, wheels with a contact width of no more than ⅛ inch are used. Ball bearings should be used for all rotational joints. And light-weight materials such as aluminum or plastic are best used in the vehicle's construction. That said, it is also important to balance the need for a low coefficient of friction with that of the need to grip its driving surface well enough so that it doesn't slide backwards when the stream is impelled against its front end.

Similarly, the precise relationships that define the mechanical advantage of the transfer of energy must be balanced to provide optimum performance. As noted above, a relationship of no less than 1:4 is recommended for the bevel gear assembly 11,12. Indeed, additional gears can be added to increase the ratio to as much as 1:12 or more, so that even relatively weak streams of air, such as those created by someone's breath blowing on the propeller 9,10, would be enough to turn the propeller against the resistance of the wheels 8. Also, the rear drive wheels 8 should be large enough in diameter so that minor bumps or dips in the driving surface do not present too great an obstacle. Yet, mechanical advantage is also affected by how large the wheels 8 are in diameter. The smaller the wheels 8, the greater the mechanical advantage conveyed. In the illustrated embodiment of a table-top version of the invention, the bevel gear ratio depicted is 1:4 and the rear wheels 8 are 3 inches in diameter. The propeller 9, 10 is 6 inches in diameter with 12 propeller blades, or vanes 10, arranged evenly around its circumference and disposed at an angle of 20 degrees from a plane set perpendicular to the axis of rotation. In any real world application, however, appropriate gear ratios, wheel diameters and propeller size and pitch will all depend on contextual issues such as the specific application, stream force and substance, preferred materials of construction, drive surface and desired speed or power of response.

### OPERATION OF INVENTION

The manner of using the illustrated embodiment of the present invention is quite simple. The vehicle is placed on a flat, level surface with all wheels 4, 8 touching the surface. Care must be taken that there is enough room in front of the vehicle for an adequate run, or so that it's progress is not inhibited by obstacles or table ledges, etc. The surface should be smooth and free of debris for best performance, but not slippery.

A supply of gas or liquid is then arranged such that a stream of it can be forced through a focused aperture and directed toward the propeller end of the vehicle 9,10. Examples of suitable arrangements might include:
A. An air compressor with hose and hand-operated nozzle attachment.
B. An inflated rubber balloon with a piece of flexible tubing extending from its neck.
C. Simply blowing at the apparatus with mouth and lungs.
D. A water hose with hand-operated nozzle.
E. A pressurized tank of gas or liquid with a hose and nozzle attachment.
F. A fan or blower, such as a hairdryer.

As the stream is directed toward the propeller 9,10 in a direction perpendicular to the plane of its face, the propeller rotates, and conducts its rotational energy down the drive shaft 3 to the bevel gears 11, 12 and through axle 7 to the rear wheels 8, which then drive the vehicle forward into the oncoming stream.

Thus operated, the vehicle provides a source of entertainment, and demonstrates in a visually and intellectually engaging way how kinetic energy can be extracted, transferred and redirected through mechanical means.

### ALTERNATIVE EMBODIMENTS

There are many possible alternative embodiments of the present invention. This invention applies to any arrangement wherein there is a rotating, vaned mechanical element for capturing kinetic energy from a stream of gas or liquid and conveying that energy to another rotating mechanical element (such as a set of wheels) that provides forward movement of the vehicle into the oncoming stream. Possibilities exist, therefore, for embodiments to include:
A. Vehicles for use in water, driven by paddlewheels.
B. Vehicles designed for use inside a closed cylindrical channel, such as a pipe, where the wheels are pressed against the sides of the pipe. A flow of gas or liquid through the pipe would thereby drive the vehicle upstream. Examples of this embodiment might include inspection vehicles for natural gas lines or even smaller ones for inspection of residential or commercial plumbing systems.
C. Devices for use in wind tunnels.
D. Full-sized vehicles for transport of humans or cargo along tracks, as in a subway system, where a blast of air is forced down the subway tunnel toward the oncoming train, thereby driving it.
E. Other full-sized vehicles.
F. Children's toys, for example, of the genre that is made from injection-molded snap-together parts and sometimes found at the bottom of cereal boxes.

### CONCLUSION

Accordingly, the reader can ascertain that the present invention provides a mechanism for driving a vehicle into an oncoming stream of gas or liquid that is vastly simplified over the prior art. By eliminating control mechanisms for steering either the vehicle or the propeller and for the varying of blade pitch, the present invention provides an economic advantage in situations where the above options are unnecessary. Whereas all the prior art references attempt to provide ways to control the vehicle's speed and direction in spite of environmental inconsistencies, the present invention is restricted by no such burden. On the contrary, the speed and direction of the present invention is controlled by environmental factors, such as flow rate of the stream and wheel restriction by tracks, pipe or tunnel walls, or by a rigid positional relationship between wheels and vehicle body.

Indeed, in the above cited situations, vehicles as described in the prior art would have not only the disadvantage of the cost of increased complexity, but also of the loss of energy due to friction. All moving parts are subject to frictional forces, and the more moving parts in a mechanism, the more there is an inherent tendency to lose energy to heat. Simplifying the mechanism has the added advantage, therefore, of reducing the loss of energy to frictional forces, thereby increasing the working efficiency of the vehicle.

### RAMIFICATIONS AND SCOPE

Although the descriptions above contain many specificities, these should not be construed as limiting the scope of the invention, but as merely providing illustrations of some of the presently preferred embodiments of this invention. For example, other propeller shapes are possible, such as vertical axis propellers, “squirrel cage” type propellers, or any such rotary vaned input device. Also, the specific design of the mechanism for transmission of rotational energy from the drive shaft to the wheels is unimportant. Other mechanical arrangements might include flexible drive shafts, chain drives, belts and pulleys, arm linkages or cams.

Thus, the scope of the invention should be determined by the appended claims and their legal equivalents, rather than by the examples given.

What is claimed is:

1. A vehicle powered by means of a stream of gas or liquid directed toward the front portion of said vehicle, such that said vehicle moves generally upstream, toward the source of said stream, said vehicle comprised of
a. a means for harnessing and transferring the kinetic energy of said stream into rotational motion, said means comprised of a rotating arrangement of angled vanes, or blades and
b. a power train for conducting said rotational motion to at least one rotating member for propelling said vehicle forward through frictional contact with a substantially dense medium, such as water, land, ice, or snow, or a floor or table top.

2. The vehicle of claim 1 wherein said means for harnessing and transfer of kinetic energy is a propeller, said propeller mounted at the front of said vehicle such that said propeller rotates about an axis substantially in line with the direction of forward movement of said vehicle.

3. The vehicle of claim 2 wherein said power train comprises a rotating shaft affixed at its forward end to said propeller and at its rear end to the input side of a speed reducer, said shaft being supported in a rotationally free manner by the body of said vehicle, the output side of said speed reducer connected to the axle of said at least one rotating member for propelling said vehicle forward, said speed reducer with means for changing the power ratio from input to output sufficiently to move said vehicle forward given pre-established stream flow.

4. The vehicle of claim 3 wherein said at least one rotating member for propelling said vehicle forward is a wheel for use upon a solid surface, such as land or a floor or table top.

5. The vehicle of claim 3 wherein said at least one rotating member for propelling said vehicle forward is a studded wheel for use upon a slick solid surface, such as ice.

6. The vehicle of claim 3 wherein said vehicle is a boat and said at least one rotating member for propelling said vehicle forward is a paddle wheel for use in water.

7. The vehicle of claim 3 wherein said vehicle is a boat and said at least one rotating member for propelling said vehicle forward is a propeller for use in water.

8. The vehicle of claim 3 wherein said vehicle is for use in enclosed channels, such as pipes, and there are at least two said rotating members for propelling said vehicle forward, said rotating members being wheels held against opposite sides of said channel with an urging means, such as a spring.

9. The vehicle of claim 3 wherein said vehicle is a subway car, and said at least one rotating member for propelling said vehicle forward is a flanged wheel engaged upon a rail or set of rails.

10. A method of propelling a vehicle forward, using a stream of gas or liquid directed toward the front portion of said vehicle, such that said vehicle moves generally upstream, toward the source of said stream, said vehicle comprised of
c. a means for harnessing and transferring the kinetic energy of said stream into rotational motion, said means comprised of a rotating arrangement of angled vanes, or blades and
d. a power train for conducting said rotational motion to at least one rotating member for propelling said vehicle forward through frictional contact with a substantially dense medium, such as water, land, ice, or snow, or a floor or table top.

11. The method of claim 10 wherein said means for harnessing and transfer of kinetic energy is a propeller, said propeller mounted at the front of said vehicle such that said propeller rotates about an axis substantially in line with the direction of forward movement of said vehicle.

12. The method of claim 11 wherein said power train comprises a rotating shaft affixed at its forward end to said propeller and at its rear end to the input side of a speed reducer, said shaft being supported in a rotationally free manner by the body of said vehicle, the output side of said speed reducer connected to the axle of said at least one rotating member for propelling said vehicle forward, said speed reducer with means for changing the power ratio from input to output sufficiently to move said vehicle forward given pre-established stream flow.

13. The method of claim 12 wherein said at least one rotating member for propelling said vehicle forward is a wheel for use upon a solid surface, such as land or a floor or table top.

14. The method of claim 12 wherein said at least one rotating member for propelling said vehicle forward is a studded wheel for use upon a slick solid surface, such as ice.

15. The method of claim 12 wherein said vehicle is a boat and said at least one rotating member for propelling said vehicle forward is a paddle wheel for use in water.

16. The method of claim 12 wherein said vehicle is a boat and said at least one rotating member for propelling said vehicle forward is a propeller for use in water.

17. The method of claim 12 wherein said vehicle is for use in enclosed channels, such as pipes, and there are at least two said rotating members for propelling said vehicle forward, said rotating members being wheels held against opposite sides of said channel with an urging means, such as a spring.

18. The method of claim 12 wherein said vehicle is a subway car, and said at least one rotating member for propelling said vehicle forward is a flanged wheel engaged upon a rail or set of rails.
